(19) United States
(12) Patent Application Publication
(10) Pub. No.: US 2018/0181532 A1
(43) Pub. Date: Jun. 28, 2018

(54) DATA TRANSFER ENDING IN PHASE DIFFERENTIAL MODES

(71) Applicant: QUALCOMM Incorporated, San Diego, CA (US)

(72) Inventor: Radu PITIGOI-ARON, San Jose, CA (US)

(21) Appl. No.: 15/845,866

(22) Filed: Dec. 18, 2017

Related U.S. Application Data
(60) Provisional application No. 62/438,102, filed on Dec. 22, 2016.

(51) Int. Cl. G06F 13/42; G06F 13/364; G06F 13/40

(52) U.S. Cl. CPC G06F 13/4291; G06F 13/4072; G06F 13/364

(57) ABSTRACT

Systems, methods, and apparatus are described that enable communication of flow-control signals over a serial bus that is operated in a phase differential mode of operation. A method performed at a device coupled to the serial bus includes transmitting first data while the serial bus is configured for a phase differential mode of operation, transmitting flow-control signaling after the first data has been transmitted, disabling a driver coupled to a first wire of the serial bus while transmitting the flow-control signaling and while the first wire is in a first signaling state, terminating data transmission when the first wire of the serial bus has transitioned to a second signaling state while the flow-control signaling is transmitted, and transmitting second data over the serial bus after transmitting the flow-control signaling when the first wire of the serial bus has remained in the first signaling state during transmission of the flow-control signaling.

### PRIORITY CLAIM

This application claims priority to and the benefit of provisional patent application No. 62/438,102 filed in the United States Patent Office on Dec. 22, 2016, the entire content of which is incorporated herein by reference as if fully set forth below in its entirety and for all applicable purposes.

### TECHNICAL FIELD

The present disclosure relates generally to an interface between processing circuits and peripheral devices and, more particularly, to providing a flow control capability through signaling on a serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

The Mobile Industry Processor Interface (MIPI) Alliance has defined standards and protocols that may be used to operate a serial bus at higher data rates than permitted when the serial bus is operated in accordance with I2C protocols. In a single data rate (SDR) mode of operation, an I3C protocol inherits certain implementation aspects from I2C protocols. SDR mode may be compatible with I2C protocols used by conventional slave devices coupled to the serial bus. The MIPI Alliance defines high data rate (HDR) modes for use on a serial bus. In one HDR mode, for example, SCL is clocked at 12.5 Mhz. Conventional slave devices that are limited to communicating through I2C protocols can coexist on the serial bus if they ignore HDR transmissions.

In many conventional serial buses, a receiver cannot signal the sender to stop transmission while the sender is actively driving the wires of the serial bus during data transfers. In the context of I2C or I3C protocols, a slave device cannot intervene to stop transmission while a master device is actively driving the wires of the I2C or I3C bus when transferring data. That is, slave devices coupled to a serial data bus have no flow control capabilities when receiving data, and cannot assert flow control signals to cause a transmitter to pause or halt a transmission. In some circumstances, a slave device may drop data and withhold acknowledgement of a transmission when the buffers in a slave device overflow. Failed transmissions due to dropped data can negative affect system latencies. Such issues are exacerbated by increasing demands on bandwidth to support increased data volumes with certain types of device. Accordingly, improvements are continually needed to improve data throughput and reduce latencies associated with serial bus interfaces.

### SUMMARY

Certain aspects of the disclosure relate to systems, apparatus, methods and techniques that provide a flow control mechanism that can be used on an I3C bus that is operated in a phase differential mode of operation.

In various aspects of the disclosure, a method performed at a transmitting device coupled to a serial bus includes transmitting first data over the serial bus while the serial bus is configured for a phase differential mode of operation, transmitting flow-control signaling over the serial bus after the first data has been transmitted, disabling a driver coupled to a first wire of the serial bus while transmitting the flow-control signaling and while the first wire is in a first signaling state, terminating data transmission over the serial bus when the first wire of the serial bus has transitioned from the first signaling state to a second signaling state while the flow-control signaling is being transmitted, and transmitting second data over the serial bus after transmitting the flow-control signaling when the first wire of the serial bus has remained in the first signaling state during transmission of the flow-control signaling.

In one aspect, the transmitting device comprises a master device, and disabling the driver coupled to the first wire of the serial bus includes causing a line driver coupled to the serial bus to enter a high impedance state, and enabling a pull-up circuit coupled to the first wire of the serial bus.

In one aspect, transmitting the first data over the serial includes encoding the first data in transitions between signaling states of the wires of the serial bus, and using each wire of the serial interface to carry encoded data.

In some aspects, transmitting the flow-control signaling includes driving the first wire to the first signaling state, and providing two or more pulses on a second wire of the serial bus after driving the first wire to the first signaling state. The transmitting device may be a slave device, and terminating data transmission over the serial bus may include driving the second wire of the serial bus while a receiving device is concurrently driving the second wire of the serial bus.

In some aspects, the serial bus is operated in accordance with an I3C protocol and the phase differential mode of operation corresponds to a high-data-rate mode of operation defined by the I3C protocol. Terminating data transmission over the serial bus may include transmitting an HDR exit pattern on the serial bus. Terminating data transmission over the serial bus may include transmitting an HDR restart pattern on the serial bus.

In various aspects of the disclosure, an apparatus includes a first line driver coupled to a first wire of a multi-wire serial bus, a second line driver coupled to a second wire of the multi-wire serial bus, a phase differential mode encoder, and an interface controller. The interface controller may be configured to transmit first data over the serial bus while the serial bus is configured for a phase differential mode of operation, transmit flow-control signaling over the serial bus after the first data has been transmitted, disable the first line driver while transmitting the flow-control signaling and while the first wire is in a first signaling state, terminate data transmission over the serial bus when the first wire of the serial bus has transitioned from the first signaling state to a second signaling state while the flow-control signaling is being transmitted, and transmit second data over the serial bus after the flow-control signaling has been transmitted and when the first wire of the serial bus has remained in the first signaling state during transmission of the flow-control signaling.

In one aspect, the apparatus is adapted to operate as a master device and the first line driver may be disabled by causing the first line driver to enter a high impedance state, and enabling a pull-up circuit coupled to the first wire of the serial bus.

In one aspect, the phase differential mode encoder is configured to encode data in transitions between signaling states of the wires of the serial bus. Each wire of the serial interface may be used to carry encoded data.

In some aspects, the interface controller may be configured to transmit the flow-control signaling by driving the first wire to the first signaling state, and providing two or more pulses on a second wire of the serial bus after driving the first wire to the first signaling state. The apparatus may be adapted to operate as a slave device and the interface controller may be configured to terminate data transmission by driving the second wire of the serial bus while a receiving device is concurrently driving the second wire of the serial bus.

In some aspects, the serial bus is operated in accordance with an I3C protocol and the phase differential mode of operation corresponds to a high-data-rate mode of operation defined by the I3C protocol. The interface controller may be configured to terminate data transmission by transmitting an HDR exit pattern on the serial bus or transmitting an HDR restart pattern on the serial bus.

In various aspects, a method performed at a receiving device coupled to a serial bus includes receiving first data from the serial bus while the serial bus is configured for a phase differential mode of operation, enabling a driver coupled to a first wire of the serial bus while flow-control signaling is being transmitted over the serial bus, and driving the first wire of the serial bus from a first signaling state to a second signaling state. Driving the first wire of the serial bus to the second signaling state while the flow-control signaling is being transmitted may be indicative of a request by the receiving device to have data transmission over the serial bus terminated.

In one aspect, the receiving device is a master device and enabling the driver coupled to the first wire of the serial bus includes causing a line driver coupled to the serial bus to exit a high impedance state.

In one aspect, receiving the first data over the serial includes decoding the first data from transitions between signaling states of the wires of the serial bus. Each wire of the serial interface is used to carry encoded data.

In one aspect, the flow-control signaling includes two or more pulses transmitted on a second wire of the serial bus after the first wire has been driven to the first signaling state.

In one aspect, the serial bus may be operated in accordance with an I3C protocol and the phase differential mode of operation corresponds to a high-data-rate mode of operation defined by the I3C protocol. The receiving device may receive an HDR exit pattern from the serial bus, where the HDR exit pattern is associated with a termination of a current data transmission over the serial bus. The receiving device may receive an HDR restart pattern from the serial bus, where the HDR restart pattern is associated with a termination of a current data transmission over the serial bus.

In various aspects, an apparatus has a first line driver coupled to a first wire of a multi-wire serial bus, a second line driver coupled to a second wire of the multi-wire serial bus, a phase differential mode encoder, and an interface controller. The interface controller may be configured to receive first data from the serial bus while the serial bus is configured for a phase differential mode of operation, enable the first line driver while flow-control signaling is being transmitted over the serial bus, and drive the first wire of the serial bus from a first signaling state to a second signaling state. Driving the first wire of the serial bus to the second signaling state while the flow-control signaling is being transmitted may be indicative of a request by the apparatus to have data transmission over the serial bus terminated.

In one aspect, the apparatus is a master device, and the first line driver may be enabled by causing the first line driver to exit a high impedance state.

In one aspect, the phase differential mode encoder may be configured to decode the first data from transitions between signaling states of the wires of the serial bus. Each wire of the serial interface is used to carry encoded data.

In some aspects, the flow-control signaling includes two or more pulses transmitted on a second wire of the serial bus after the first wire has been driven to the first signaling state. The apparatus may include a master device and data transmission over the serial bus includes driving the second wire of the serial bus while a transmitting device is concurrently driving the second wire of the serial bus.

In some aspects, the serial bus is operated in accordance with an I3C protocol and the phase differential mode of operation corresponds to a high-data-rate mode of operation defined by the I3C protocol. The apparatus may receive an HDR exit pattern or an HDR restart pattern from the serial bus, where the HDR exit pattern and the HDR restart pattern are associated with a termination of a current data transmission over the serial bus.

### BRIEF DESCRIPTION OF THE DRAWINGS

FIG. 1 illustrates an apparatus employing a data link between IC devices that is selectively operated according to one of plurality of available standards.

FIG. 2 illustrates a communication link in which a configuration of devices are connected using a serial bus.

FIG. 3 illustrates certain aspects of an apparatus that includes multiple devices connected to a serial bus.

FIG. 4 includes a timing diagram that illustrates signaling on a serial bus when the serial bus is operated in a single data rate mode of operation defined by I3C specifications.

FIG. 5 is a timing diagram 500 that illustrates an example of a transmission in an I3C high data rate mode, where data is transmitted in signaling state of a serial bus.

FIG. 6 illustrates an example of signaling transmitted on the SDA wire and SCL wire of a serial bus to initiate certain mode changes.

FIGS. 7 and 8 provide timing diagrams that illustrate an example of flow-control asserted by a slave device during transmission of data from a master device to the slave device.

FIGS. 9 and 10 provide timing diagrams that illustrate an example of flow-control asserted by a master device during transmission of data from a slave device to the master device.

FIG. 11 illustrates an example of line driving circuits that may be used to provide hardware flow control in accordance with certain aspects disclosed herein.

FIG. 12 is a block diagram illustrating an example of an apparatus employing a processing circuit that may be adapted according to certain aspects disclosed herein.

FIG. 13 is a flowchart 1300 illustrating a flow-control process that may be performed at a sending device coupled to a serial bus in accordance with certain aspects disclosed herein.

FIG. 14 illustrates a hardware implementation for a transmitting apparatus adapted to respond to a provide a flow control capability in accordance with certain aspects disclosed herein.

FIG. 15 is a flowchart illustrating a flow-control process that may be performed at a receiving device coupled to a serial bus in accordance with certain aspects disclosed herein.

FIG. 16 illustrates a hardware implementation for a receiving apparatus adapted to respond to a flow control capability in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Apparatus that includes one or more SoCs or other IC devices may include or be coupled to peripherals, sensors, and other components that care communicatively coupled through a serial bus. In one example, a serial bus may be employed to connect an application processor or other host device with modems, sensors and/or other peripherals. The serial bus may be operated in accordance with specifications and protocols defined by a standards body. The serial bus may be operated in accordance with a standard or protocol such as the I2C, I3C, serial low-power inter-chip media bus (SLIMbus), system management bus (SMB), radio frequency front-end (RFFE) protocols that define timing relationships between signals and transmissions.

Flow control may be implemented for devices coupled to a serial bus. In an example, flow-control signaling may be transmitted on a serial bus configured for a phase differential mode of operation after a first block of data is transmitted. According to certain aspects disclosed herein, a transmitter may disable a driver coupled to a first wire of the serial bus while flow-control signaling is being transmitted. The transmitter may terminate one or more transactions over the serial bus when a receiving device drives the serial bus while the flow-control signaling is transmitted.

The conventional I2C protocols provides for data transmission using open-drain line drivers that permit a limited degree of feedback from a receiver. For example, the ACK/NACK bit that follows every byte (8 bits) of data transmitted over an I2C serial bus may be used to signal that an error has occurred and may lead to termination of the current transaction. In the I2C context, data is driven using open-drain mode line drivers and the receiver can control the signaling state of the ACK/NACK bit to signal the sender that the transmission should be terminated. In the I2C example, the receiver may be a slave device when a master device is performing a write, and the receiver may be a master device when the master device is performing a read from a slave device.

In accordance with certain aspects disclosed herein, a sender and receiver may mutually agree and/or recognize opportunities provided for the receiver to signal a request to terminate a transmission. A receiver may signal a request to terminate a transmission or may refrain from responding to the opportunity to request termination. In some examples, devices coupled to a multi-wire bus may be adapted according to certain aspects disclosed herein such that a receiver can signal a request to terminate transmission by controlling or otherwise manipulating control bits transmitted by the sender on the multi-wire bus. In some examples, devices coupled to a multi-wire bus may be adapted according to certain aspects disclosed herein such that a receiver can signal a request to terminate transmission by controlling or otherwise manipulating signaling periodically transmitted by the sender over the multi-wire bus.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

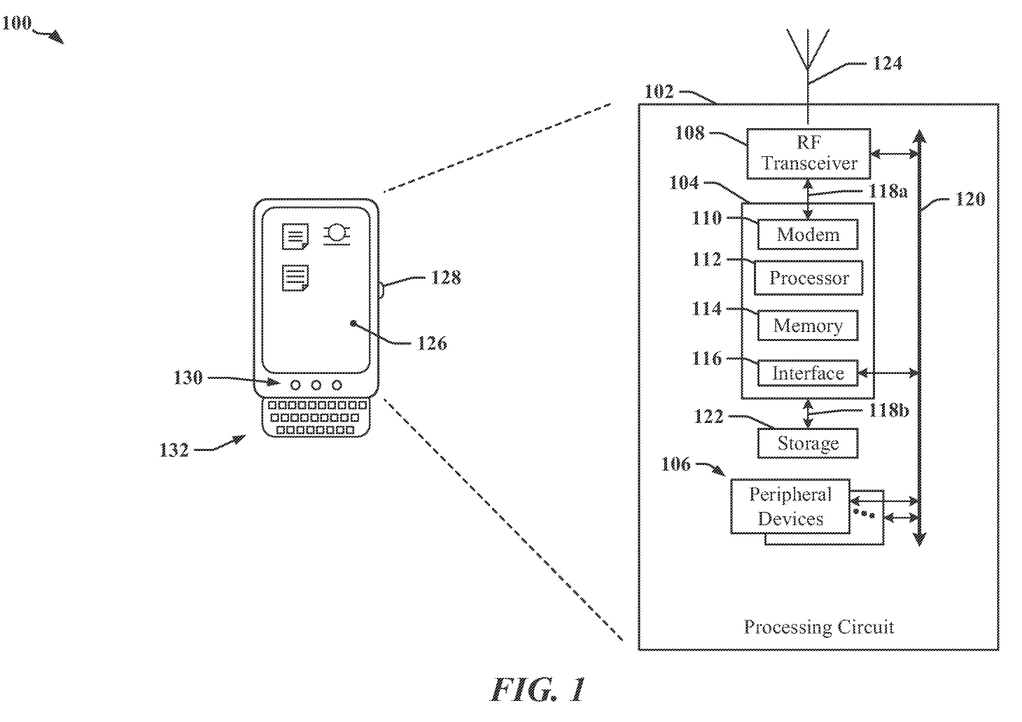

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

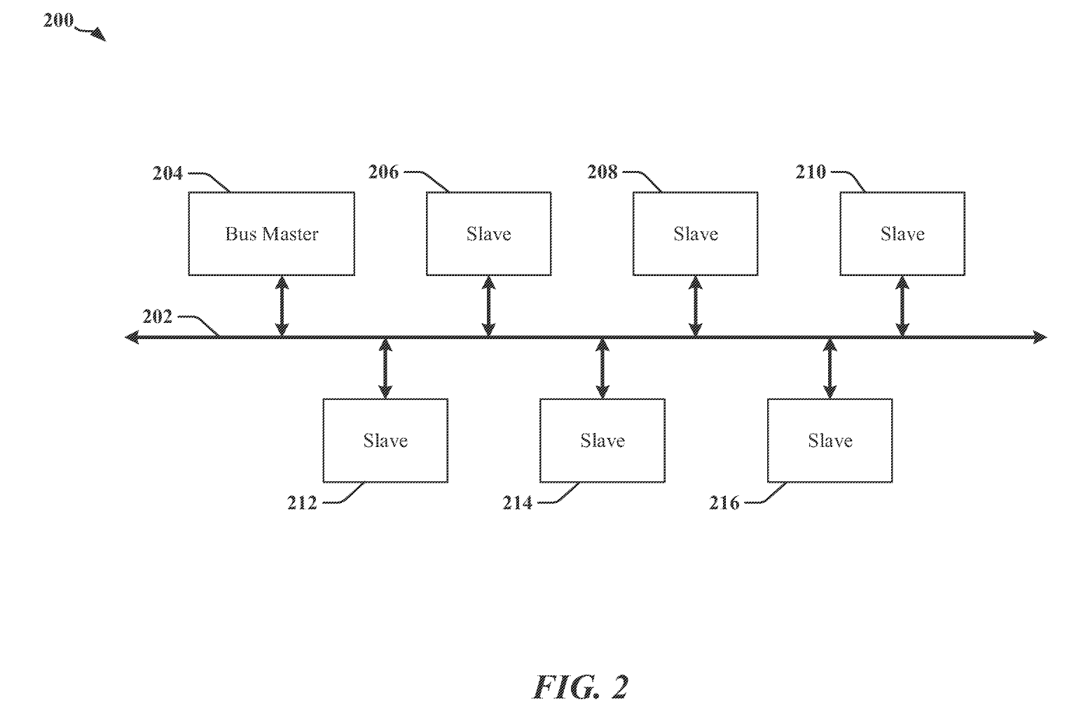

FIG. 2 illustrates a communication link 200 in which a configuration of devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols, where timing information is embedded in the transmission of the symbols.

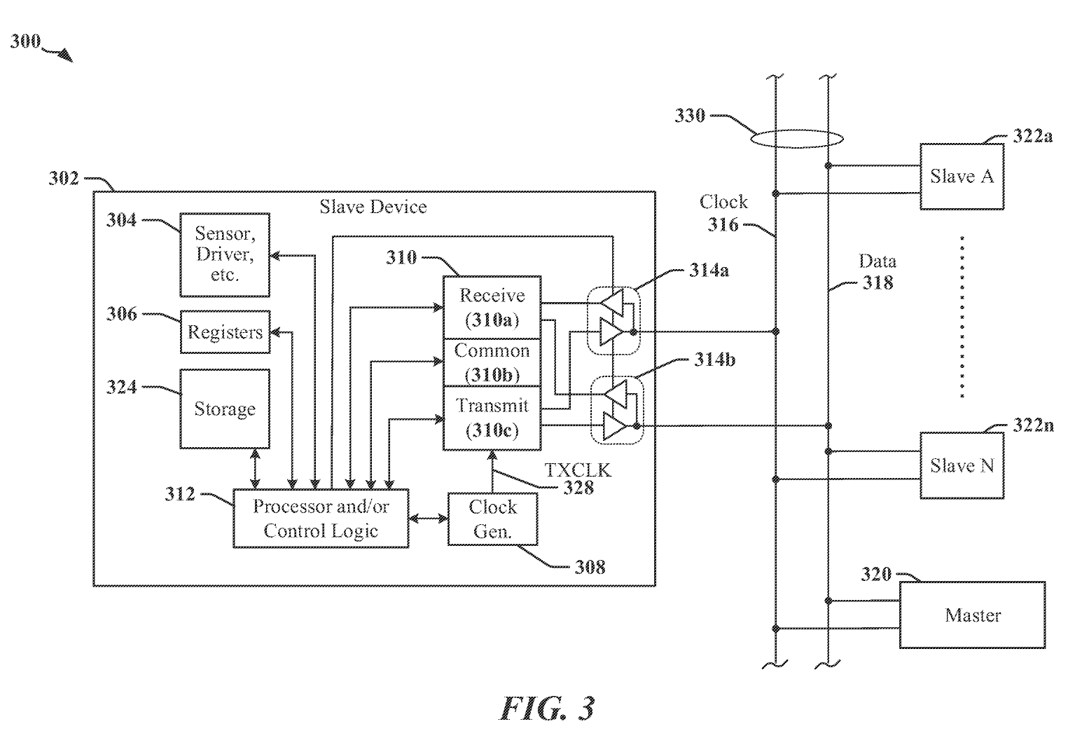

FIG. 3 illustrates certain aspects of an apparatus 300 that includes multiple devices 302, 320 and 322a-322n connected to a serial bus 330. The serial bus 330 may include a first wire 316 that carries a clock signal in certain modes of operation while a second wire 318 carries a data signal. In other modes of operation, data may be encoded in multi-bit symbols, where each bit of the symbol controls signaling state of one of the wires 316, 318. The devices 302, 320 and 322a-322n may include one or more semiconductor IC devices, such as an applications processor, SoC or ASIC. Each of the devices 302, 320 and 322a-322n may include, support or operate as a modem, a signal processing device, a display driver, a camera, a user interface, a sensor, a sensor controller, a media player, a transceiver, and/or other such components or devices. Communications between devices 302, 320 and 322a-322n over the serial bus 330 is controlled by a bus master 320. Certain types of bus can support multiple bus masters 320.

The apparatus 300 may include multiple devices 302, 320 and 322a-322n that communicate when the serial bus 330 is operated in accordance with I2C, I3C or other protocols. At least one device 302, 322a-322n may be configured to operate as a slave device on the serial bus 330. In one example, a slave device 302 may be adapted to provide a sensor control function 304. The sensor control function 304 may include circuits and modules that support an image sensor, and/or circuits and modules that control and communicate with one or more sensors that measure environmental conditions. The slave device 302 may include configuration registers 306 or other storage 324, control logic 312, a transceiver 310 and line drivers/receivers 314a and 314b. The control logic 312 may include a processing circuit such as a state machine, sequencer, signal processor or general-purpose processor. The transceiver 310 may include a receiver 310a, a transmitter 310c and common circuits 310b, including timing, logic and storage circuits and/or devices. In one example, the transmitter 310c encodes and transmits data based on timing provided by a clock generation circuit 308.

Two or more of the devices 302, 320 and/or 322a-322n may be adapted according to certain aspects and features disclosed herein to support a plurality of different communication protocols over a common bus, which may include an SMBus protocol, an SPI protocol, an I2C protocol, and/or an I3C protocol. In some examples, devices that communicate using one protocol (e.g., an I2C protocol) can coexist on the same serial bus with devices that communicate using a second protocol (e.g., an I3C protocol). In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 3-wire serial bus 330, in addition to data formats and aspects of bus control. In some aspects, the I2C and I3C protocols may define direct current (DC) characteristics affecting certain signal levels associated with the serial bus 330, and/or alternating current (AC) characteristics affecting certain timing aspects of signals transmitted on the serial bus 330.

High-Speed Data Transfers Over an I3C Serial Bus

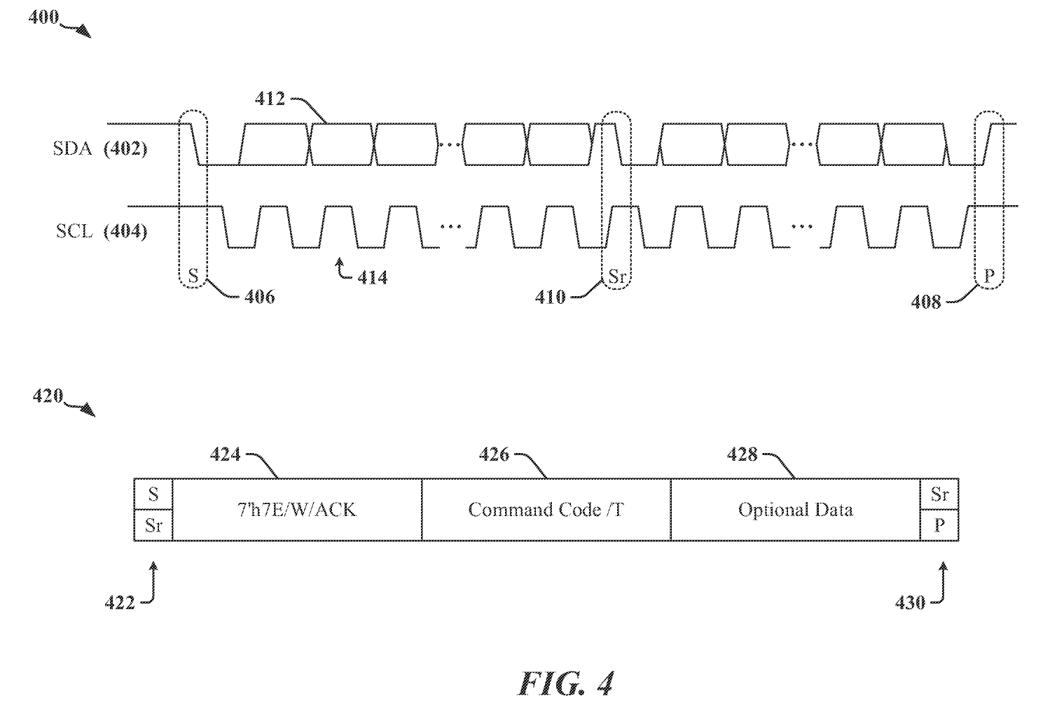

FIG. 4 includes a timing diagram 400 that illustrates signaling on a serial bus when the serial bus is operated in a single data rate (SDR) mode of operation defined by I3C specifications. Data transmitted on a first wire (the SDA wire 402) of the serial bus may be captured using a clock signal transmitted on a second wire (the SCL wire 404) of the serial bus. During data transmission, the signaling state 412 of the SDA wire 402 is expected to remain constant for the duration of the pulses 414 when the SCL wire 404 is at a high voltage level. Transitions on the SDA wire 402 when the SCL wire 404 is at the high voltage level indicate a START condition 406, a STOP condition 408 or a repeated START 410.

On an I3C serial bus, a START condition 406 is defined to permit the current bus master to signal that data is to be transmitted. The START condition 406 occurs when the SDA wire 402 transitions from high to low while the SCL wire 404 is high. The bus master may signal completion and/or termination of a transmission using a STOP condition 408. The STOP condition 408 is indicated when the SDA wire 402 transitions from low to high while the SCL wire 404 is high. A repeated START 410 may be transmitted by a bus master that wishes to initiate a second transmission upon completion of a first transmission. The repeated START 410 is transmitted instead of, and has the significance of a STOP condition 408 followed immediately by a START condition 406. The repeated START 410 occurs when the SDA wire 402 transitions from high to low while the SCL wire 404 is high.

The bus master may transmit an initiator 422 that may be a START condition 406 or a repeated START 410 prior to transmitting an address of a slave, a command, and/or data. FIG. 4 illustrates a command code transmission 420 by the bus master. The initiator 422 may be followed in transmission by a predefined command 424 indicating that a command code 426 is to follow. The command code 426 may, for example, cause the serial bus to transition to a desired mode of operation. In some instances, data 428 may be transmitted. The command code transmission 420 may be followed by a terminator 430 that may be a STOP condition 408 or a repeated START 410.

Certain serial bus interfaces support one or more phase differential modes of operation, in which data is encoded in phase differences of two or more wires. In one example, data may be encoded as a straightforward phase difference. In another example, data may be encoded using numerical conventions to calculate phase differences. In various examples, a phase differential mode of operation may encode data in transitions between signaling states of the wires of a serial bus. Increased data transfer rates may be obtained when, for example, both wires of an I3C bus are used for encoding data, with clock information encoded by ensuring that a change in signaling state of at least one wire occurs at each transition between signaling states of the serial bus.

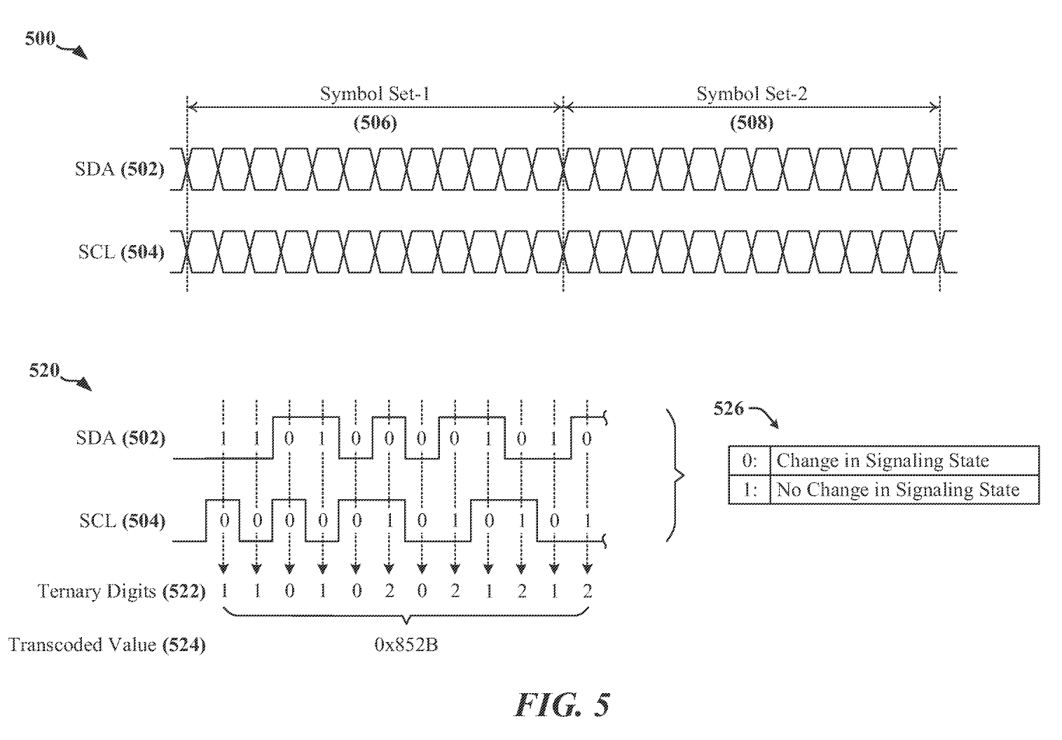

FIG. 5 is a timing diagram 500 that illustrates an example of a transmission in an I3C high data rate (HDR) mode, where data is transmitted in signaling state of the SDA wire 402 and the SCL wire 404. In the I3C HDR mode, data is transcoded to ternary numbers or symbols that are used to define a type of transition in signaling state of the serial bus. In one example, three bits of data are converted to 2-bit ternary number. Each 18-bit data word may be encoded in 12 symbols, where each symbol can select from one of three possible transitions of signaling state on the serial bus. A two-wire serial bus driven between binary voltage levels provides four possible signaling states. According to certain I3C specifications, a pair of consecutively transmitted signaling states must be different, thereby causing at least one wire to change signaling state at the transition. At each transition, the three available signaling states are selected by the value of a ternary symbol.

FIG. 5 includes an example of signaling 520 that illustrates decoding of an HDR mode transmission in accordance with certain I3C protocols. Ternary digits 522 are generated based each transition between signaling states of the SDA wire 402 and the SCL wire 404. The table 526 illustrates one method of assigning ternary values to a transition in signaling state of the SDA wire 402 and the SCL wire 404. For example, a binary number representing the transition may have its least significant bit set to ‘0’ when a change in signaling state was observed on the SDA wire 402 and set to ‘1’ when no change in signaling state was observed on the SDA wire 402. The most significant bit of the binary number may be set to ‘0’ when a change in signaling state was observed on the SCL wire 404 and set to ‘1’ when no change in signaling state was observed on the SCL wire 404. Since a transition must occur on at least one wire 402 or 404, the binary number is not set to ‘11’ and the resultant 2-bit binary number represents a ternary value. When all 12 symbols have been received, each pair of digits in the 12-bit binary number may be transcoded to obtain an 18-bit data word 524.

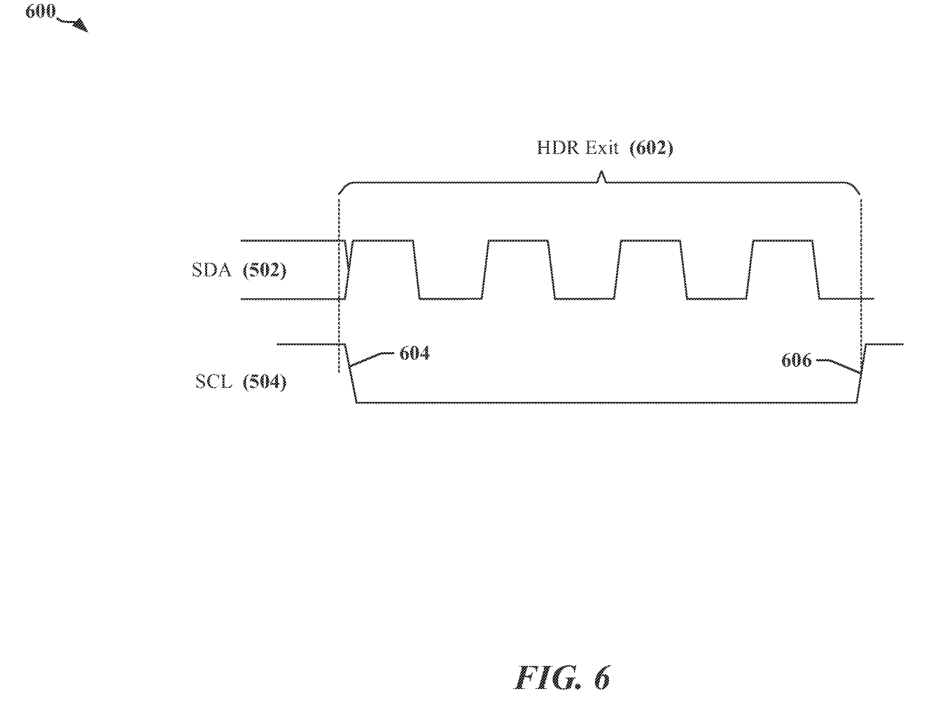

FIG. 6 illustrates an example of signaling 600 transmitted on the SDA wire 502 and SCL wire 504 to initiate certain mode changes. The signaling 600 is defined by I3C protocols for use in initiating restart, exit and/or break from I3C HDR modes of communication. The signaling 600 includes an HDR Exit 602 that may be used to cause an HDR break or exit. The HDR Exit 602 commences with a falling edge 604 on the SCL wire 504 and ends with a rising edge 606 on the SCL wire 504. While the SCL wire 504 is in low signaling state, four pulses are transmitted on the SDA wire 502. I2C devices ignore the SDA wire 502 when no pulses are provided on the SCL wire 504.

Flow Control for Phase Differential Modes

Various examples discussed herein may be based on or refer to an I3C bus operated in accordance with MIPI Alliance protocols. For example, certain modes defined by I3C standards and protocols employ phase differential encoding, including the I3C HDR Ternary Symbols mode. The use of HDR Ternary Symbols mode and other I3C modes defined by the MIPI Alliance are referenced as examples only, and the principles disclosed herein are applicable in other contexts and for other communications protocols, specifications and standards. For example, certain aspects disclosed herein may be implemented in multi-wire interfaces, such as a serial bus that includes three or more lines, where all lines are actively driven by a sender. In one example, procedures described below for a two-wire link may be implemented on a link that includes two wires operated as described for the two-wire link, and while other wires are maintained in an open-drain pull-up state.

In phase differential modes, the sender of the data actively drives all physical lines of the interface, such that no lines are available to permit a receiver to signal flow-control requests to the sender. Consequently, the receiver is required to absorb all transmitted data, irrespective of whether the receiver can use the data, store the data or forward the data to its intended destination. Situations may occur where data is discarded when, for example, memory space in the receiver is exhausted, when the data transfer occurs too quickly for the processor or other circuits to handle incoming data, or when the receiver is busy performing other tasks, etc.

Certain aspects disclosed herein provide circuits and techniques by which a receiver can request the sender to terminate or suspend data transfer. The disclosed circuits and techniques may be employed to implement a flow control mechanism when all physical lines are being driven by the sender. In some examples, a mutually agreed control protocol is implemented between the sender and the receiver. In the example of a link operated in accordance with an I3C protocol, a Common Command Code (CCC) may be exchanged over the interface to set specific parameters of the protocol that may be used for flow control. For example, the protocol may define a flow-control pattern periodically transmitted during multi-word data transfers and the CCC may indicate the number of data words to be transmitted between flow-control patterns. The flow-control pattern, which may also be referred to as a “data transfer ending pattern,” may take a variety of formats based on application, mode of communication and the protocol used by an interface.

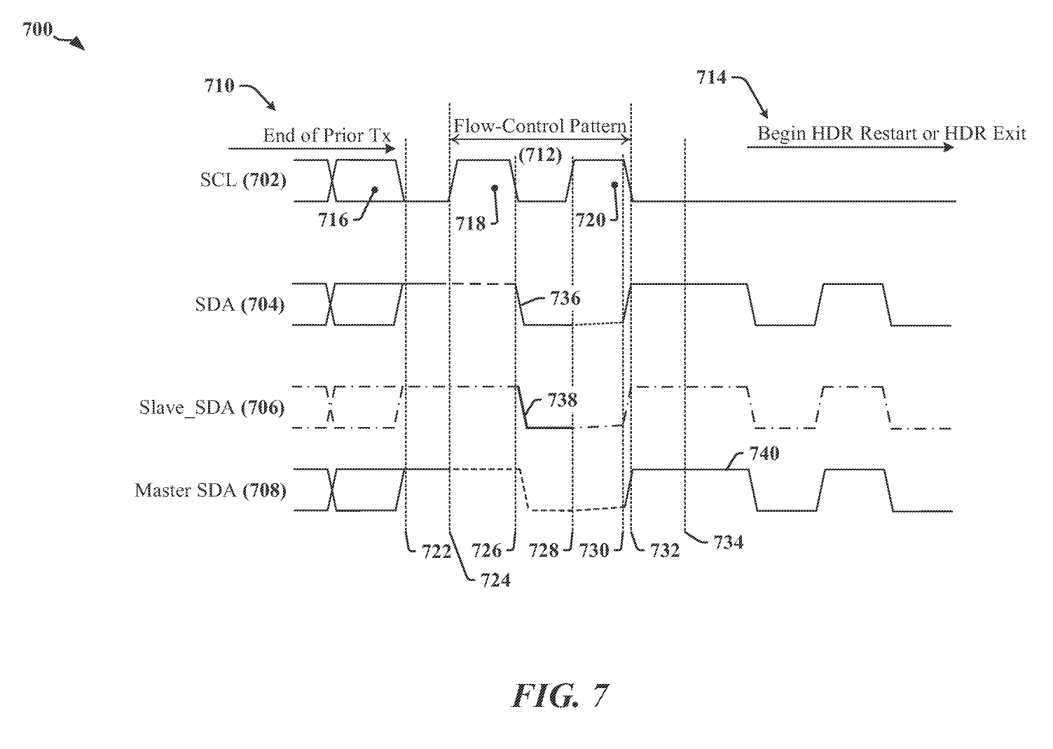

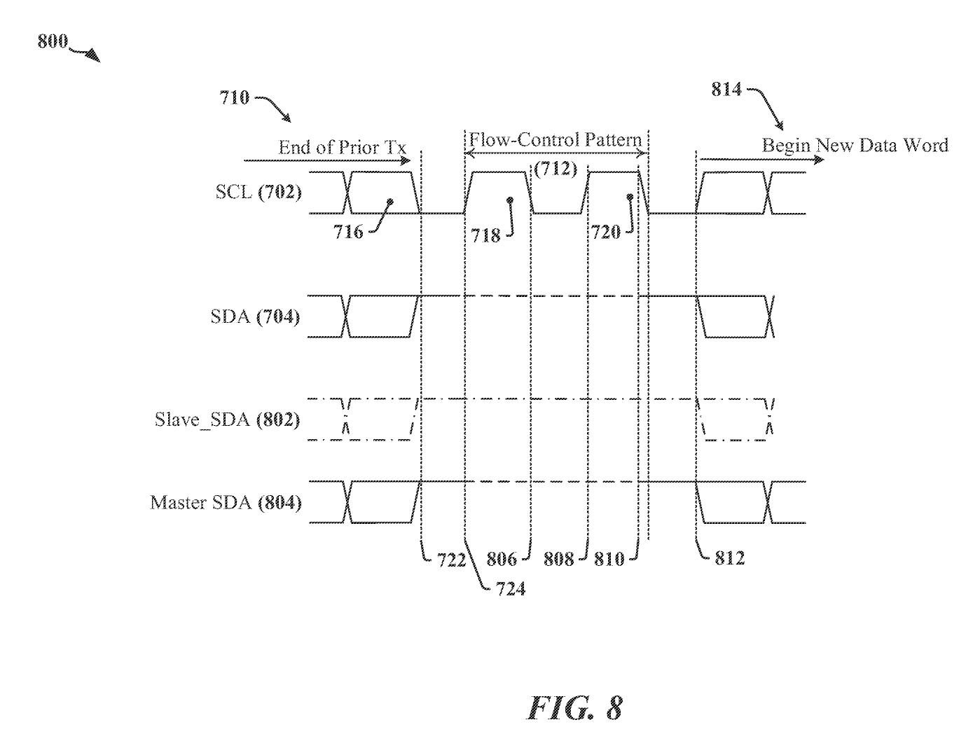

FIGS. 7 and 8 provide timing diagrams 700, 800 that illustrate examples of flow-control asserted by a slave device during transmission of data from a master device to the slave device. The timing diagrams 700, 800 depict signaling on the SCL wire 702 and the SDA wire 704. In the illustrated examples, the SCL wire 702 is driven by the master device, while the SDA wire 704 may be driven by either the master device or the slave device. Line drivers in the master device and the slave devices coupled to the SDA wire 704 may be operable in a tristate mode. A pull-up resistor, a keeper circuit, or the like, may be coupled to the SDA wire 704 to hold a signaling state when the line drivers are operated in tristate mode. In some examples, a pull-up resistor may be coupled to the SDA wire 704 through a switch. The timing diagram 700 depicts a Slave_SDA signal 706 corresponding to a line driver in the slave device, and a Master_SDA signal 708 corresponding to a line driver in the master device. The representation of the Slave_SDA signal 706 uses solid lines to indicate periods when the SDA wire 704 is actively driven by the line driver in the slave device. The representation of the Master_SDA signal 708 uses solid lines to indicate periods when the SDA wire 704 is actively driven by the line driver in the master device. The combination of the Master_SDA signal 708 and the Slave_SDA signal 706 may result in the signal transmitted on the SDA wire 704.

A flow-control pattern 712 may be transmitted by the master device between word transmissions to indicates when a slave device can assert a flow-control request. In various examples, the flow-control pattern 712 may include a sequence of pulses transmitted the SCL wire 702 and/or the SDA wire 704. In the illustrated example, the flow-control pattern 712 includes two pulses 718, 720 transmitted on the SCL wire 702 after a first transaction or other transmission 710.

The flow-control pattern 712 indicates an opportunity for a slave device receiving data from the master device to provide flow-control feedback to the master device requesting that the master device terminate or suspend transmissions. At a first point in time 722, the last ternary symbol 716 of the first transmission 710 has been sent, and the master device drives the SCL wire 702 low and the SDA wire 704 high. At a second point in time 724, the master device begins driving the SCL wire 702 to provide a rising edge of a first clock pulse 718. The master device may also disable the line driver coupled to the SDA wire 704 and enable an open-drain class pull-up circuit or structure coupled to the SDA wire 704. At a third point in time 726 corresponding to the falling edge of the first clock pulse 718, the slave device drives the SDA wire 704 low to provide a falling edge 736 on the SDA wire 704.

The master device monitors the SDA wire 704 and may determine that the slave device is requesting termination or suspension of data transmission when the SDA wire 704 has been driven low. The slave device may release the SDA wire 704 at a fourth point in time 728 corresponding to the rising edge of a second clock pulse 720 by causing a line driver to enter a high impedance mode. At a fifth point in time 730 prior to the falling edge of the second clock pulse 720, the master device may disable its open-drain class pull-up circuit or structure coupled to the SDA wire 704 and enable the line driver coupled to the SDA wire 704. The master device may then drive the SDA wire 704 high and initiate a falling edge of the second clock pulse 720. At a sixth point in time 732, the master device has caused the SDA wire 704 to be actively driven to a high state while the SCL wire 702 is actively driven to a low state. Line drivers of the slave device coupled to the SCL wire 702 and the SDA wire 704 are in high-impedance states. At a seventh point in time 734, after a ternary symbol duration, the master device may transmit a pattern signaling HDR Restart or HDR EXIT 714, terminating the data transfer from the master device to the slave device.

The timing diagram 800 illustrates a second example in which a slave device receiving data from the master device refrains from providing flow-control feedback to the master device, such that the master device continues transmissions. At a first point in time 722, the last ternary symbol 716 of the first transmission 710 has been sent, and the master device drives the SCL wire 702 low and the SDA wire 704 high. At a second point in time 724, the master device begins driving the SCL wire 702 to provide a rising edge of a first clock pulse 718. The master device may also disable the line driver coupled to the SDA wire 704 and enable an open-drain class pull-up circuit or structure coupled to the SDA wire 704. At a third point in time 806 corresponding to the falling edge of the first clock pulse 718, the slave device has the opportunity to assert flow-control on the SDA wire 704. In this example, the line drivers of the slave device coupled to the SCL wire 702 and the SDA wire 704 remain in high-impedance states.

The master device monitors the SDA wire 704 and may determine at a fourth point in time 808 corresponding to the rising edge of a second clock pulse 720 that the slave device is not requesting termination or suspension of data transmission when the SDA wire 704 has remained high. At a fifth point in time 810 prior to the falling edge of the second clock pulse 720, the master device may disable the open-drain class pull-up circuit or structure coupled to the SDA wire 704 and enable the line driver coupled to the SDA wire 704. The master device may then drive the SDA wire 704 high and initiate a falling edge of the second clock pulse 720. At a sixth point in time 812, the master device has caused the SDA wire 704 to be actively driven to a high state while the SCL wire 702 is actively driven to a low state. Line drivers of the slave device coupled to the SCL wire 702 and the SDA wire 704 are in high-impedance states. The master device may start transmitting a new data word 814, continuing the data transfer from the master device to the slave device.

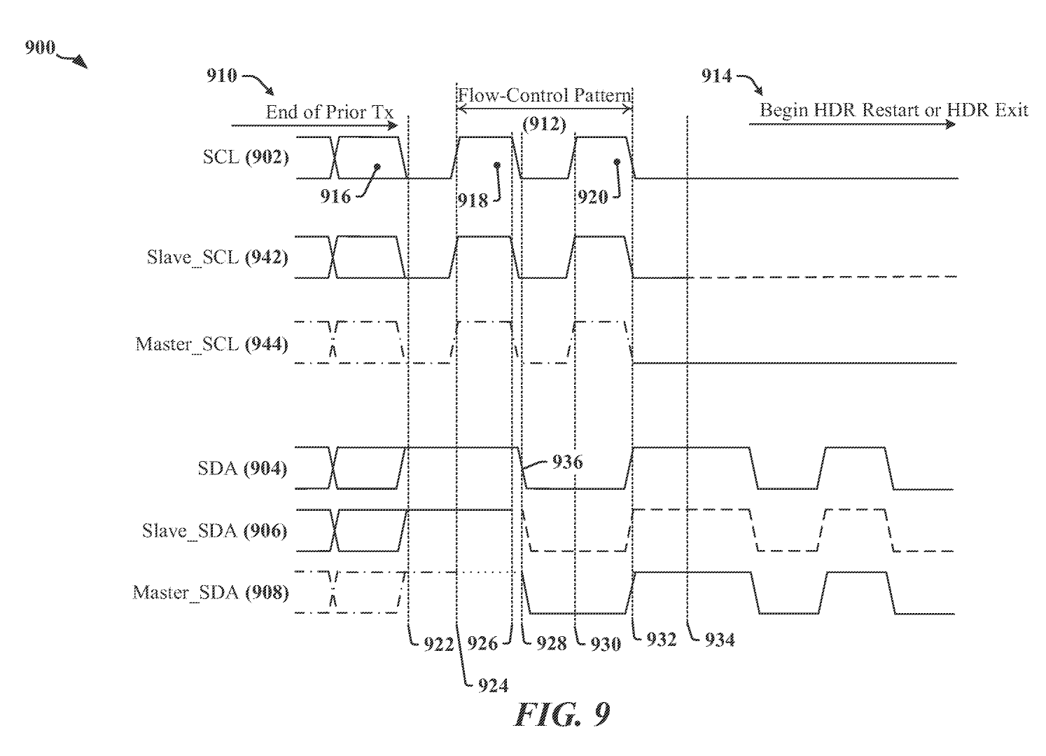

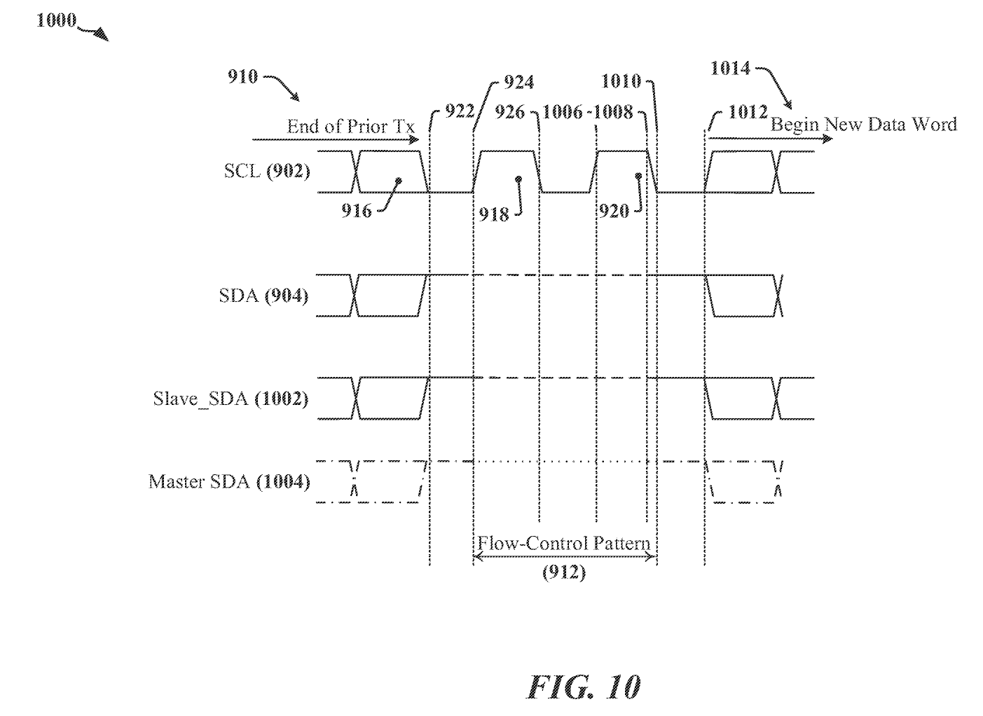

FIGS. 9 and 10 provide timing diagrams 900, 1000 that illustrate an example of flow-control asserted by a master device during transmission of data from a slave device to the master device. The timing diagrams 900, 1000 depict signaling on the SCL wire 902 and the SDA wire 904. In the illustrated examples, the SCL wire 902 and the SDA wire 904 may be driven by either the master device or the slave device. Line drivers in the master device and the slave devices that are coupled to the SDA wire 904 may be operable in a tristate mode such that a pull-up resistor or the like may be coupled to the SDA wire 904 when the line drivers are operated in tristate mode. In some examples, the pull-up resistor may be coupled to the SDA wire 904 through a switch. The timing diagram 900 depicts a Slave_SDA signal 906 that is produced by a line driver in the slave device, and a master_SDA signal 908 that is produced by a line driver in the master device. The representation of the Slave_SDA signal 906 uses solid lines to indicate periods when the SDA wire 904 is actively driven by the line driver in the slave device. The representation of the Master_SDA signal 908 uses solid lines to indicate periods when the SDA wire 904 is actively driven by the line driver in the master device. The combination of the master_SDA signal 908 and the Slave_SDA signal 906 may result in the signal transmitted on the SDA wire 904.

A flow-control pattern 912 may be transmitted by the slave device between word transmissions to provide a master device with the opportunity to assert a flow-control request. In various examples, the flow-control pattern 912 may include a sequence of pulses transmitted on the SCL wire 902 and/or the SDA wire 904. In the illustrated example, the flow-control pattern 912 include two pulses 918, 920 that are transmitted on the SCL wire 902 after a first transmission 910.

The timing diagram 900 illustrates a first example in which a master device receiving data from the slave device provides flow-control feedback to the slave device requesting that the slave device terminate or suspend transmissions. After the last ternary symbol 916 of the first transmission 910 has been sent at a first point in time 922, the slave device drives the SCL wire 902 low and the SDA wire 904 high. At a second point in time 924, the master device may enable an open-drain class pull-up circuit or structure coupled to the SDA wire 904. At a third point in time 924, the slave device begins driving the SCL wire 902 to provide a rising edge of a first clock pulse 918. The slave device may also disable the line driver coupled to the SDA wire 904, by causing the line driver to enter a high impedance mode for example.

At a fourth point in time 928, the master device begins driving the SDA wire 904 low to provide a falling edge 936 on the SDA wire 904. The slave device is monitoring the SDA wire 904, and at a fifth point in time 930 the slave device may determine that the master device is requesting termination or suspension of data transmission when the SDA wire 904 has been driven low. At a sixth point in time 932, the master device may drive the SDA wire 904 high and start driving the SCL wire 902 low, concurrently with the slave device. At a seventh point in time 934, the master device has caused the SDA wire 904 to be actively driven to a high state while actively driving the SCL wire 902 to a low state. The slave device may cease driving the SCL wire 902. Line drivers of the slave device coupled to the SCL wire 902 and the SDA wire 904 may be configured for high-impedance state. The master device may transmit a pattern signaling HDR Restart or HDR EXIT 914, terminating the data transfer from the slave device to the master device.

The timing diagram 1000 illustrates a second example in which a master device receiving data from the slave device refrains from providing flow-control feedback to the slave device, such that the slave device continues transmissions. After the last ternary symbol 916 of the first transmission 910 has been sent at a first point in time 922, the slave device drives the SCL wire 902 low and the SDA wire 904 high. At a second point in time 924, the master device may enable an open-drain class pull-up circuit or structure coupled to the SDA wire 904. At a third point in time 924, the slave device begins driving the SCL wire 902 to provide a rising edge of a first clock pulse 918. The slave device may also disable the line driver coupled to the SDA wire 904, by causing the line driver to enter a high impedance mode, for example.

The slave device is monitoring the SDA wire 904, and at a fourth point in time 1006, the slave device may determine that the master device is not requesting termination or suspension of data transmission when the SDA wire 904 remains high. At a fifth point in time 1008, the slave device may drive the SDA wire 904 high and start driving the SCL wire 902 low. At a sixth point in time 1010, the master device may disable the open-drain class pull-up circuit or structure coupled to the SDA wire 904 and cause a line driver coupled to the SDA wire 704 to enter a high-impedance output state. At a seventh point in time 1012, and after a ternary symbol duration, the slave device may begin transmitting a new data word 1014, continuing the data transfer from the slave device to the master device.

Certain aspects of flow-control implementation may be configured during device construction, during startup or initialization, and/or by configuration command, under application control and at other times. In one example, the frequency at which the flow-control pattern 712, 912 is transmitted may be configured based on application requirements. The frequency of occurrence of the flow-control pattern 712, 912 may be selected to optimize data throughput and/or latency. Flow control for phase differential data transfer protocols accomplished through the insertion of a flow-control pattern 712, 912 can decrease overall data throughput. In one example involving the HDR Ternary Symbols mode defined by MIPI Alliance protocols, opportunities to terminate data transfer can be provided approximately every 8 μs, with an expected decrease in data throughput of approximately 2.6%. In other examples, the repetition period for transmitting a flow-control pattern 712, 912 may be significantly longer, covering batches of data in order of 1 kB. In such examples, the flow-control pattern 712, 912 adds 5 symbols for every 6000 data symbols, with a 0.08% throughput reduction.

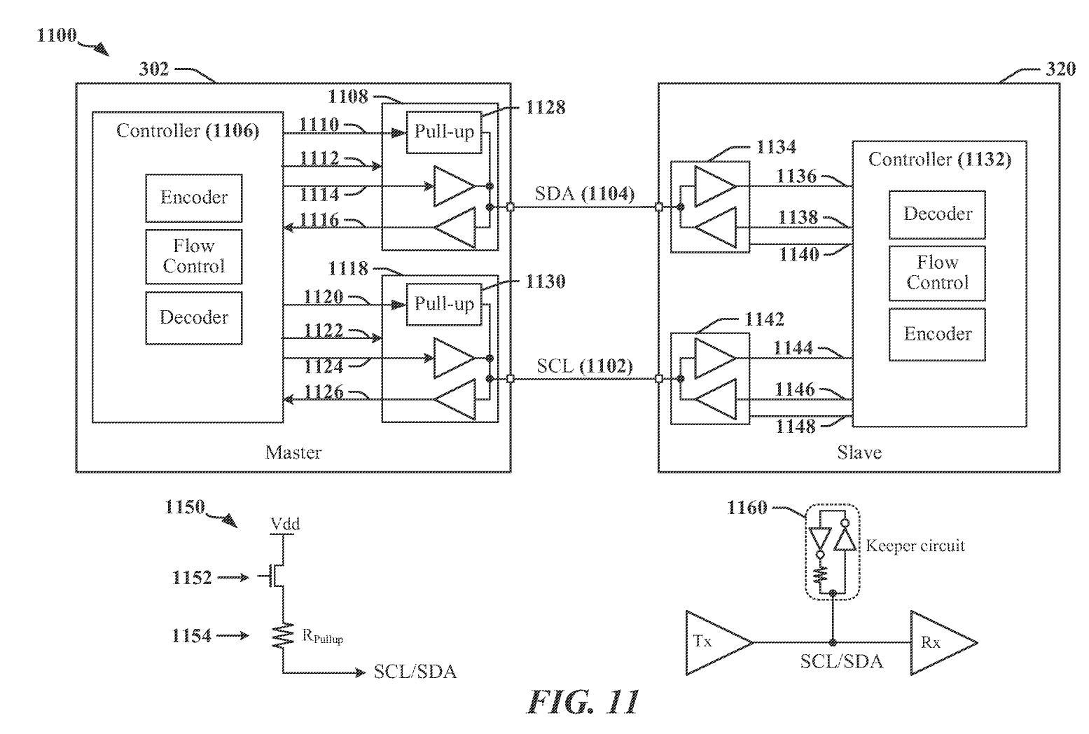

FIG. 11 illustrates an example of an I3C interface 1100 that has been adapted in accordance with certain aspects disclosed herein. A master device 302 is coupled to the SCL wire 1102 and SDA wire 1104 of a serial interface. A slave device 320 is also coupled to the SCL wire 1102 and SDA wire 1104 of the serial interface. The master device 302 and the slave device 320 include respective interface controllers 1106, 1132 that may include encoders, decoders and flow control circuits and modules.

The master device 302 and the slave device 320 include transceivers 1108, 1118, 1134 and 1142 that may be used to transmit and receive signals over a respective wire 1102, 1104. The transceivers 1108, 1118 in the master device 302 include pull-up circuits or structures 1128, 1130 which may be used to emulate an open-drain pull-up coupled to the SCL wire 1102 and SDA wire 1104. The interface controller 1106 in the master device 302 may provide a control signal 1110, 1120 that enables or disables the operation of corresponding pull-up circuits or structures 1128, 1130.

The interface controller 1106 in the master device 302 may provide impedance control signals 1112, 1122 that can be used to place line drivers in the transceivers 1108, 1118 into a high-impedance mode of operation. The interface controller 1106 in the master device 302 may provide a master SDA signal 1114 (see also the signals on the master_SDA wires 708, 804, 908 and 1004), and receive an SDA_signal 1116 from the SDA wire 1104 (see also the signals on the SDA wire 704, 904). The interface controller 1106 in the master device 302 may provide a master SCL signal 1124 and receive an SCL_signal 1126 from the SCL wire 1102 (see also the signals on the SCL wires 702, 902).

The interface controller 1132 in the slave device 320 may provide impedance control signals 1140, 1148 that can be used to place line drivers in the transceivers 1134, 1142 into a high-impedance mode of operation. The interface controller 1132 in the slave device 320 may provide a slave SDA signal 1138 (see also the Slave_SDA wires 706, 802, 906 and 1002), and receive an SDA_signal 1136 from the SDA wire 1104 (see also the signals on the SDA wires 704, 904). The interface controller 1132 in the slave device 320 may provide a slave SCL signal 1144 and receive an SCL_signal 1146 from the SCL wire 1102 (see also the signals on the SCL wires 702, 902).

The pull-up circuits or structures 1128, 1130 may be implemented using a variety of circuits. In one example, a pull-up circuit 1150 includes a pull-up resistor 1154 that may be coupled to a source of high voltage (V_{dd}) through a switch 1152. In some instances, the switch 1152 may be implemented as a suitably configured transistor. In some instances, the pull-up resistor 1154 may be coupled directly to V_{dd} where the switch 1152 couples the pull-up structure to the SCL wire 1102 or SDA wire 1104. In another example, the pull-up circuits or structures 1128, 1130 may be implemented using a keeper circuit 1160. The keeper circuit 1160 may be configured as a positive feedback circuit that drives the SCL wire 1102 or SDA wire 1104 through a high impedance output, and receives feedback from the SCL wire 1102 or SDA wire 1104 through a low impedance input. The keeper circuit 1160 may be configured to maintain the last asserted voltage on the SCL wire 1102 or SDA wire 1104. The keeper circuit 1160 can be easily overcome by line drivers in the master device 302 or slave device 320.

Examples of Processing Circuits and Methods

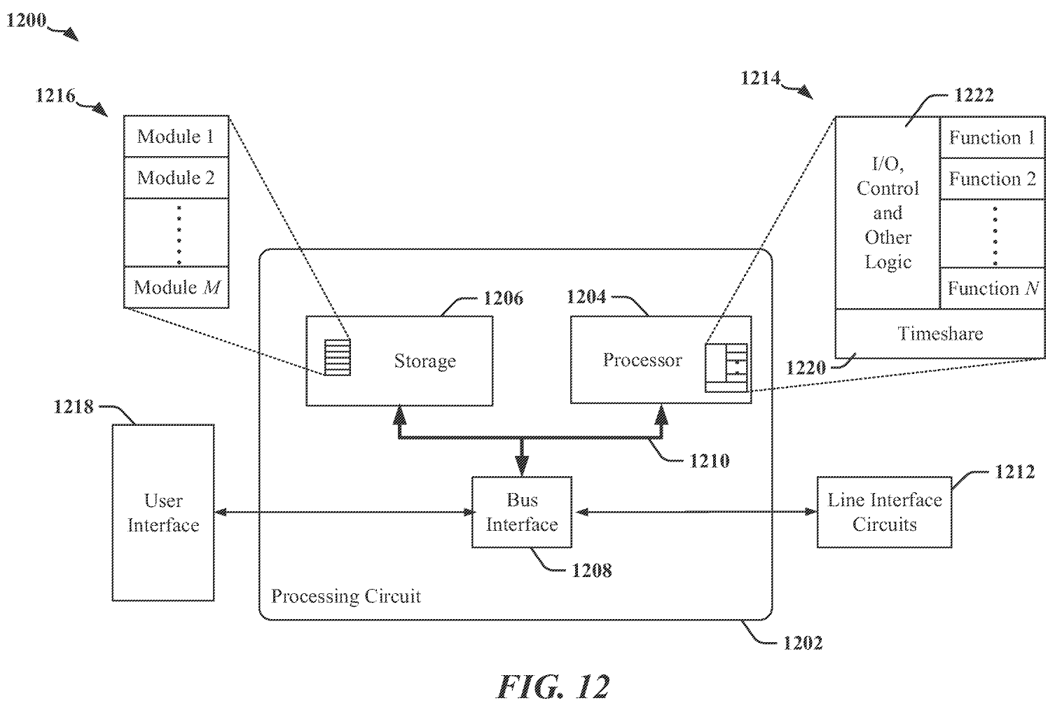

FIG. 12 is a diagram illustrating an example of a hardware implementation for an apparatus 1200 employing a processing circuit 1202 that may be configured to perform one or more functions disclosed herein. In accordance with various aspects of the disclosure, an element, or any portion of an element, or any combination of elements as disclosed herein may be implemented using the processing circuit 1202. The processing circuit 1202 may include one or more processors 1204 that are controlled by some combination of hardware and software modules. Examples of processors 1204 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1204 may include specialized processors that perform specific functions, and that may be configured, augmented or controlled by one of the software modules 1216. The one or more processors 1204 may be configured through a combination of software modules 1216 loaded during initialization, and further configured by loading or unloading one or more software modules 1216 during operation. In various examples, the processing circuit 1202 may be implemented using a state machine, sequencer, signal processor and/or general-purpose processor, or a combination of such devices and circuits.

In the illustrated example, the processing circuit 1202 may be implemented with a bus architecture, represented generally by the bus 1210. The bus 1210 may include any number of interconnecting buses and bridges depending on the specific application of the processing circuit 1202 and the overall design constraints. The bus 1210 links together various circuits including the one or more processors 1204, and storage 1206. Storage 1206 may include memory devices and mass storage devices, and may be referred to herein as computer-readable media and/or processor-readable media. The bus 1210 may also link various other circuits such as timing sources, timers, peripherals, voltage regulators, and power management circuits. A bus interface 1208 may provide an interface between the bus 1210 and one or more transceivers 1212. A transceiver 1212 may be provided for each networking technology supported by the processing circuit. In some instances, multiple networking technologies may share some or all of the circuitry or processing modules found in a transceiver 1212. Each transceiver 1212 provides a means for communicating with various other apparatus over a transmission medium. Depending upon the nature of the apparatus 1200, a user interface 1218 (e.g., keypad, display, speaker, microphone, joystick) may also be provided, and may be communicatively coupled to the bus 1210 directly or through the bus interface 1208.

A processor 1204 may be responsible for managing the bus 1210 and for general processing that may include the execution of software stored in a computer-readable medium that may include the storage 1206. In this respect, the processing circuit 1202, including the processor 1204, may be used to implement any of the methods, functions and techniques disclosed herein. The storage 1206 may be used for storing data that is manipulated by the processor 1204 when executing software, and the software may be configured to implement any one of the methods disclosed herein.

One or more processors 1204 in the processing circuit 1202 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1206 or in an external computer-readable medium. The external computer-readable medium and/or storage 1206 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1206 may also include, by way of example, a carrier wave, a transmission line, and any other suitable medium for transmitting software and/or instructions that may be accessed and read by a computer. Computer-readable medium and/or the storage 1206 may reside in the processing circuit 1202, in the processor 1204, external to the processing circuit 1202, or be distributed across multiple entities including the processing circuit 1202. The computer-readable medium and/or storage 1206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1206 may maintain software maintained and/or organized in loadable code segments, modules, applications, programs, etc., which may be referred to herein as software modules 1216. Each of the software modules 1216 may include instructions and data that, when installed or loaded on the processing circuit 1202 and executed by the one or more processors 1204, contribute to a run-time image 1214 that controls the operation of the one or more processors 1204. When executed, certain instructions may cause the processing circuit 1202 to perform functions in accordance with certain methods, algorithms and processes described herein.

Some of the software modules 1216 may be loaded during initialization of the processing circuit 1202, and these software modules 1216 may configure the processing circuit 1202 to enable performance of the various functions disclosed herein. For example, some software modules 1216 may configure internal devices and/or logic circuits 1222 of the processor 1204, and may manage access to external devices such as the transceiver 1212, the bus interface 1208, the user interface 1218, timers, mathematical coprocessors, and so on. The software modules 1216 may include a control program and/or an operating system that interacts with interrupt handlers and device drivers, and that controls access to various resources provided by the processing circuit 1202. The resources may include memory, processing time, access to the transceiver 1212, the user interface 1218, and so on.

One or more processors 1204 of the processing circuit 1202 may be multifunctional, whereby some of the software modules 1216 are loaded and configured to perform different functions or different instances of the same function. The one or more processors 1204 may additionally be adapted to manage background tasks initiated in response to inputs from the user interface 1218, the transceiver 1212, and device drivers, for example. To support the performance of multiple functions, the one or more processors 1204 may be configured to provide a multitasking environment, whereby each of a plurality of functions is implemented as a set of tasks serviced by the one or more processors 1204 as needed or desired. In one example, the multitasking environment may be implemented using a timesharing program 1220 that passes control of a processor 1204 between different tasks, whereby each task returns control of the one or more processors 1204 to the timesharing program 1220 upon completion of any outstanding operations and/or in response to an input such as an interrupt. When a task has control of the one or more processors 1204, the processing circuit is effectively specialized for the purposes addressed by the function associated with the controlling task. The timesharing program 1220 may include an operating system, a main loop that transfers control on a round-robin basis, a function that allocates control of the one or more processors 1204 in accordance with a prioritization of the functions, and/or an interrupt driven main loop that responds to external events by providing control of the one or more processors 1204 to a handling function.

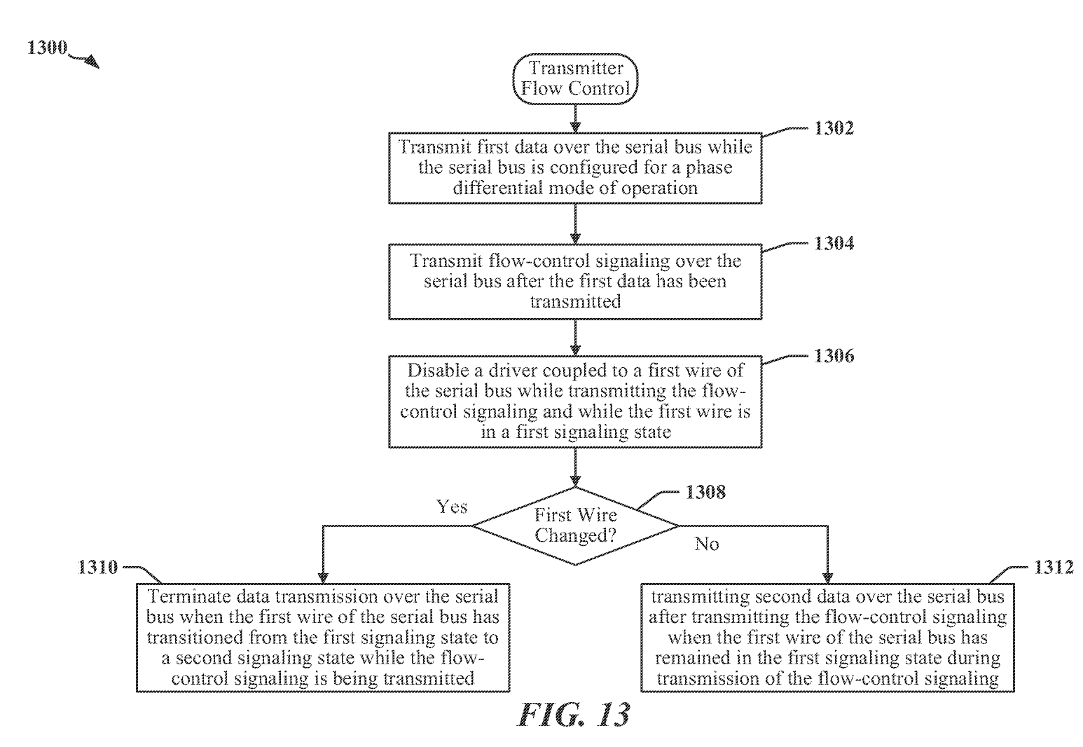

FIG. 13 is a flowchart 1300 illustrating a flow-control process that may be performed at a sending device coupled to a serial bus.

At block 1302, the sending device may transmit first data over the serial bus while the serial bus is configured for a phase differential mode of operation.

At block 1304, the sending device may transmit flow-control signaling over the serial bus after the first data has been transmitted.

At block 1306, the sending device may disable a driver coupled to a first wire of the serial bus while transmitting the flow-control signaling and while the first wire is in a first signaling state.

At block 1306, the sending device may determine whether the signaling state of the first wire has changed.

At block 1308, the sending device may terminate data transmission over the serial bus when the first wire of the serial bus has transitioned from the first signaling state to a second signaling state while the flow-control signaling is being transmitted; and

At block 1310, the sending device may transmit second data over the serial bus after transmitting the flow-control signaling when the first wire of the serial bus has remained in the first signaling state during transmission of the flow-control signaling.

In various examples, the sending device comprises a master device. The driver coupled to the first wire of the serial bus may be disabled by causing a line driver coupled to the serial bus to enter a high impedance state, and enabling a pull-up circuit coupled to the first wire of the serial bus.

In some examples, the first data may be transmitted over the serial by encoding the first data in transitions between signaling states of the wires of the serial bus, and using each wire of the serial interface to carry encoded data.

In various examples, the flow-control signaling may be transmitted by driving the first wire to the first signaling state, and providing two or more pulses on a second wire of the serial bus after driving the first wire to the first signaling state. The sending device may be a slave device, and terminating the data transmission over the serial bus may include driving the second wire of the serial bus while a receiving device is concurrently driving the second wire of the serial bus.

In various examples, the serial bus is operated in accordance with an I3C protocol and the phase differential mode of operation corresponds to a HDR mode of operation defined by the I3C protocol. Terminating data transmission over the serial bus may include transmitting an HDR exit pattern on the serial bus, or transmitting an HDR restart pattern on the serial bus.

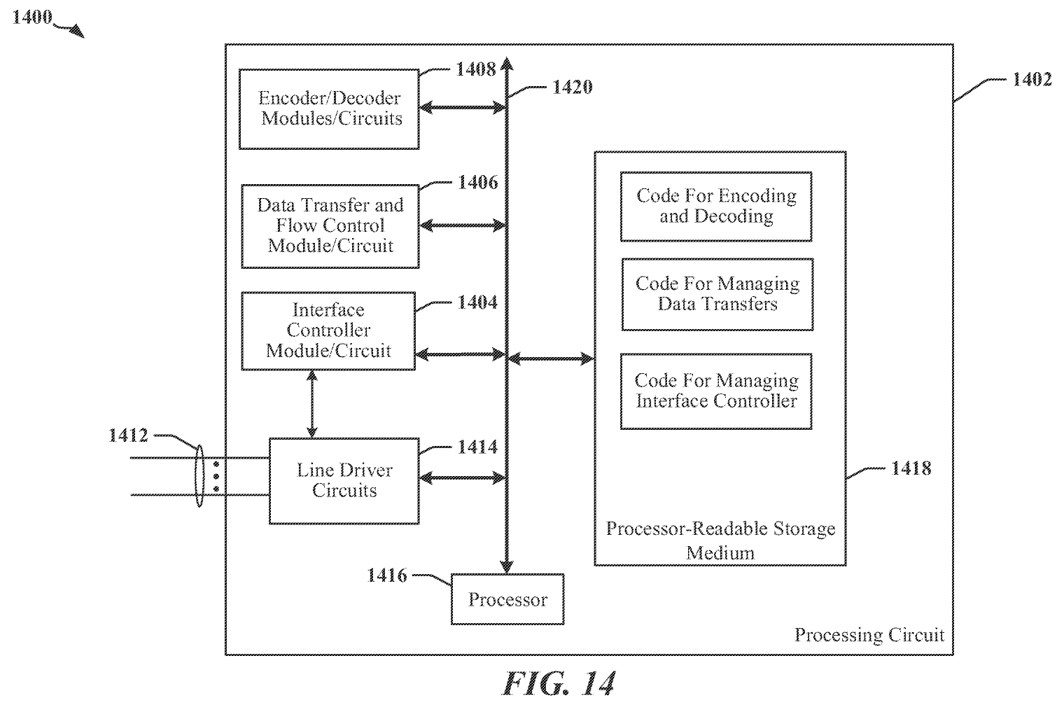

FIG. 14 is a diagram illustrating a simplified example of a hardware implementation for an apparatus 1400 employing a processing circuit 1402. The processing circuit typically has a controller or processor 1416 that may include one or more microprocessors, microcontrollers, digital signal processors, sequencers and/or state machines. The processing circuit 1402 may be implemented with a bus architecture, represented generally by the bus 1420. The bus 1420 may include any number of interconnecting buses and bridges depending on the specific application of the processing circuit 1402 and the overall design constraints. The bus 1420 links together various circuits including one or more processors and/or hardware modules, represented by the controller or processor 1416, the modules or circuits 1404, 1406 and 1408, and the computer-readable storage medium 1418. The apparatus may be coupled to a multi-wire communication link using a physical layer circuit 1414. The physical layer circuit 1414 may operate the multi-wire communication link 1412 to support communications in accordance with I3C protocols. The bus 1420 may also link various other circuits such as timing sources, peripherals, voltage regulators, and power management circuits, which are well known in the art, and therefore, will not be described any further.

The processor 1416 is responsible for general processing, including the execution of software, code and/or instructions stored on the computer-readable storage medium 1418. The computer-readable storage medium may include a non-transitory storage medium. The software, when executed by the processor 1416, causes the processing circuit 1402 to perform the various functions described supra for any particular apparatus. The computer-readable storage medium may be used for storing data that is manipulated by the processor 1416 when executing software. The processing circuit 1402 further includes at least one of the modules 1404, 1406 and 1408. The modules 1404, 1406 and 1408 may be software modules running in the processor 1416, resident/stored in the computer-readable storage medium 1418, one or more hardware modules coupled to the processor 1416, or some combination thereof. The modules 1404, 1406 and 1408 may include microcontroller instructions, state machine configuration parameters, or some combination thereof.

In one configuration, the apparatus 1400 includes an interface controller, a first line driver coupled to a first wire of a multi-wire serial bus and a second line driver coupled to a second wire of the multi-wire serial bus. The modules 1404, 1406 and 1408 includes a phase differential mode encoder. The apparatus 1400 includes modules and/or circuits 1404, 1406 configured to transmit first data over the serial bus while the serial bus is configured for a phase differential mode of operation and transmit flow-control signaling over the serial bus after the first data has been transmitted, modules and/or circuits 1404 configured to disable the first line driver while transmitting the flow-control signaling and while the first wire is in a first signaling state, terminate data transmission over the serial bus when the first wire of the serial bus has transitioned from the first signaling state to a second signaling state while the flow-control signaling is being transmitted, and transmit second data over the serial bus after the flow-control signaling has bene transmitted and when the first wire of the serial bus has remained in the first signaling state during transmission of the flow-control signaling.

In some examples, the apparatus 1400 is adapted to operate as a master device, and the first line driver is disabled by causing the first line driver to enter a high impedance state, and enabling a pull-up circuit coupled to the first wire of the serial bus.

In one example, the phase differential mode encoder is configured to encode data in transitions between signaling states of the wires of the serial bus. Each wire of the serial interface may be used to carry encoded data.

In various examples, the interface controller may be configured to transmit the flow-control signaling by driving the first wire to the first signaling state, and providing two or more pulses on a second wire of the serial bus after driving the first wire to the first signaling state. The apparatus 1400 may be adapted to operate as a slave device, and the interface controller may be configured to terminate data transmission by driving the second wire of the serial bus while a receiving device is concurrently driving the second wire of the serial bus.

In various examples, the serial bus is operated in accordance with an I3C protocol and the phase differential mode of operation corresponds to an HDR mode of operation defined by the I3C protocol. The interface controller may be configured to terminate data transmission by transmitting an HDR exit pattern on the serial bus or transmitting an HDR restart pattern on the serial bus.

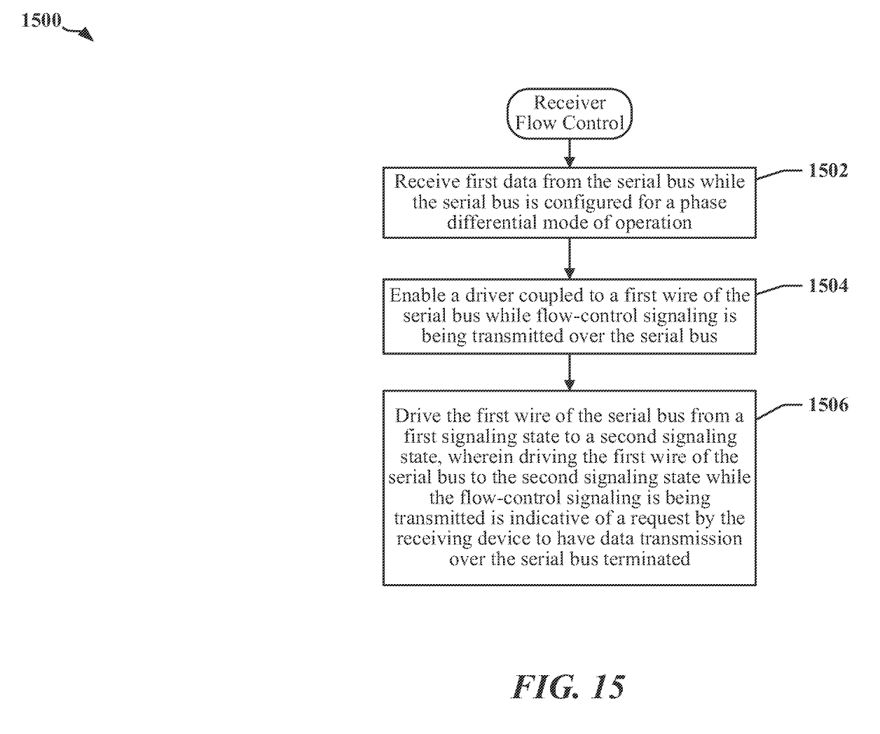

FIG. 15 is a flowchart 1500 illustrating a flow-control process that may be performed at a receiving device coupled to a serial bus.

At block 1502, the receiving device may receive first data from the serial bus while the serial bus is configured for a phase differential mode of operation.

At block 1504, the receiving device may enable a driver coupled to a first wire of the serial bus while flow-control signaling is being transmitted over the serial bus.

At block 1506, the receiving device may drive the first wire of the serial bus from a first signaling state to a second signaling state. Driving the first wire of the serial bus to the second signaling state while the flow-control signaling is being transmitted may be indicative of a request by the receiving device to have data transmission over the serial bus terminated.

In one example, the receiving device is a master device, and enabling the driver coupled to the first wire of the serial bus includes causing a line driver coupled to the serial bus to exit a high impedance state.

In another example, receiving the first data over the serial includes decoding the first data from transitions between signaling states of the wires of the serial bus. Each wire of the serial interface may be used to carry encoded data.

In another example, the flow-control signaling includes two or more pulses transmitted on a second wire of the serial bus after the first wire has been driven to the first signaling state.

In various examples, the serial bus is operated in accordance with an I3C protocol and the phase differential mode of operation corresponds to an HDR mode of operation defined by the I3C protocol. An HDR exit pattern or HDR restart pattern may be received from the serial bus. The HDR exit pattern and HDR restart pattern may be associated with a termination of a current data transmission over the serial bus.

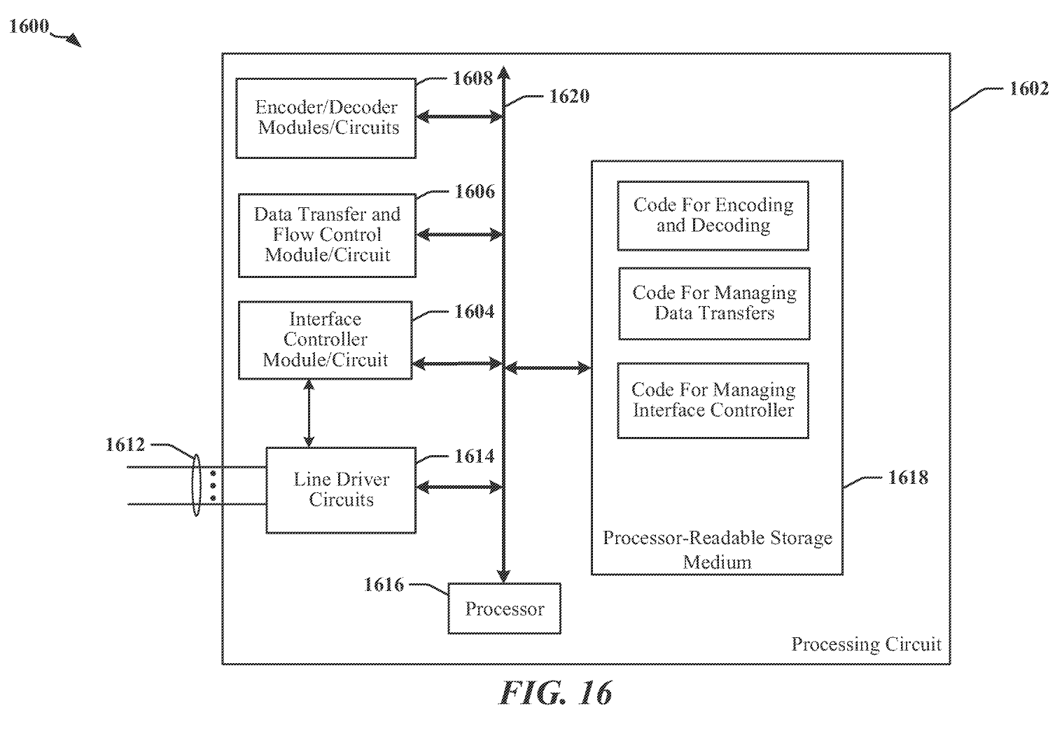

FIG. 16 is a diagram illustrating a simplified example of a hardware implementation for an apparatus 1600 employing a processing circuit 1602. The processing circuit typically has a controller or processor 1616 that may include one or more microprocessors, microcontrollers, digital signal processors, sequencers and/or state machines. The processing circuit 1602 may be implemented with a bus architecture, represented generally by the bus 1620. The bus 1620 may include any number of interconnecting buses and bridges depending on the specific application of the processing circuit 1602 and the overall design constraints. The bus 1620 links together various circuits including one or more processors and/or hardware modules, represented by the controller or processor 1616, the modules or circuits 1604, 1606 and 1608, and the computer-readable storage medium 1618. The apparatus may be coupled to a multi-wire communication link using a physical layer circuit 1614. The physical layer circuit 1614 may operate the multi-wire communication link 1612 to support communications in accordance with an I2C and/or I3C protocol. The bus 1620 may also link various other circuits such as timing sources, peripherals, voltage regulators, and power management circuits, which are well known in the art, and therefore, will not be described any further.

The processor 1616 is responsible for general processing, including the execution of software, code and/or instructions stored on the computer-readable storage medium 1618. The computer-readable storage medium may include a non-transitory storage medium. The software, when executed by the processor 1616, causes the processing circuit 1602 to perform the various functions described supra for any particular apparatus. The computer-readable storage medium may be used for storing data that is manipulated by the processor 1616 when executing software. The processing circuit 1602 further includes at least one of the modules 1604, 1606 and 1608. The modules 1604, 1606 and 1608 may be software modules running in the processor 1616, resident/stored in the computer-readable storage medium 1618, one or more hardware modules coupled to the processor 1616, or some combination thereof. The modules 1604, 1606 and 1608 may include microcontroller instructions, state machine configuration parameters, or some combination thereof.

In one configuration, the apparatus 1600 includes a first line driver coupled to a first wire of a multi-wire serial bus, a second line driver coupled to a second wire of the multi-wire serial bus, and encoder and/or decoder modules and circuits configured to provide a phase differential mode encoder. The apparatus 1600 may include modules and/or circuits 1604, 1606 configured to receive first data from the serial bus while the serial bus is configured for a phase differential mode of operation, enable the first line driver while flow-control signaling is being transmitted over the serial bus, and drive the first wire of the serial bus from a first signaling state to a second signaling state. Driving the first wire of the serial bus to the second signaling state while the flow-control signaling is being transmitted is indicative of a request by the receiving device to have data transmission over the serial bus terminated.

In one example, the apparatus 1600 may be a master device, and the first line driver may be enabled by causing the first line driver to exit a high impedance state.

In another example, the phase differential mode encoder is configured to decode the first data from transitions between signaling states of the wires of the serial bus. Each wire of the serial interface is used to carry encoded data.

In various examples, the flow-control signaling includes two or more pulses transmitted on a second wire of the serial bus after the first wire has been driven to the first signaling state. The apparatus 1600 may be a master device, and data may be transmitted over the serial bus by driving the second wire of the serial bus while a transmitting device is concurrently driving the second wire of the serial bus. The serial bus may be operated in accordance with an I3C protocol and the phase differential mode of operation corresponds to a HDR mode of operation defined by the I3C protocol. The apparatus 1600 may receive an HDR exit pattern or an HDR restart pattern from the serial bus, where the HDR exit pattern and the HDR restart pattern are associated with a termination of a current data transmission over the serial bus.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at a transmitting device coupled to a serial bus, comprising:
transmitting first data over the serial bus while the serial bus is configured for a phase differential mode of operation;
transmitting flow-control signaling over the serial bus after the first data has been transmitted;
disabling a driver coupled to a first wire of the serial bus while transmitting the flow-control signaling and while the first wire is in a first signaling state;
terminating data transmission over the serial bus when the first wire of the serial bus has transitioned from the first signaling state to a second signaling state while the flow-control signaling is being transmitted; and
transmitting second data over the serial bus after transmitting the flow-control signaling when the first wire of the serial bus has remained in the first signaling state during transmission of the flow-control signaling.

2. The method of claim 1, wherein the transmitting device comprises a master device, and wherein disabling the driver coupled to the first wire of the serial bus comprises:
causing a line driver coupled to the serial bus to enter a high impedance state; and
enabling a pull-up circuit coupled to the first wire of the serial bus.

3. The method of claim 1, wherein transmitting the first data over the serial comprises:
encoding the first data in transitions between signaling states of the wires of the serial bus; and
using each wire of the serial bus to carry encoded data.

4. The method of claim 1, wherein transmitting the flow-control signaling comprises:
driving the first wire to the first signaling state; and
providing two or more pulses on a second wire of the serial bus after driving the first wire to the first signaling state.

5. The method of claim 4, wherein the transmitting device comprises a slave device, and wherein terminating data transmission over the serial bus comprises:
driving the second wire of the serial bus while a receiving device is concurrently driving the second wire of the serial bus.

6. The method of claim 1, wherein the serial bus is operated in accordance with an I3C protocol and the phase differential mode of operation corresponds to a high-data-rate (HDR) mode of operation defined by the I3C protocol.

7. The method of claim 6, wherein terminating data transmission over the serial bus comprises:
transmitting an HDR exit pattern on the serial bus.

8. The method of claim 1, wherein terminating data transmission over the serial bus comprises:
transmitting an HDR restart pattern on the serial bus.

9. An apparatus, comprising:
a first line driver coupled to a first wire of a multi-wire serial bus;
a second line driver coupled to a second wire of the multi-wire serial bus;
a phase differential mode encoder; and
an interface controller configured to:
transmit first data over the serial bus while the serial bus is configured for a phase differential mode of operation;
transmit flow-control signaling over the serial bus after the first data has been transmitted;
disable the first line driver while transmitting the flow-control signaling and while the first wire is in a first signaling state;
terminate data transmission over the serial bus when the first wire of the serial bus has transitioned from the first signaling state to a second signaling state while the flow-control signaling is being transmitted; and
transmit second data over the serial bus after the flow-control signaling has been transmitted and when the first wire of the serial bus has remained in the first signaling state during transmission of the flow-control signaling.

10. The apparatus of claim 9, wherein the apparatus is adapted to operate as a master device, and wherein the first line driver is disabled by:
causing the first line driver to enter a high impedance state; and
enabling a pull-up circuit coupled to the first wire of the serial bus.

11. The apparatus of claim 9, wherein the phase differential mode encoder is configured to:
encode data in transitions between signaling states of the wires of the serial bus, wherein each wire of the serial bus is used to carry encoded data.

12. The apparatus of claim 9, wherein the interface controller is configured to transmit the flow-control signaling by:
driving the first wire to the first signaling state; and
providing two or more pulses on a second wire of the serial bus after driving the first wire to the first signaling state.

13. The apparatus of claim 12, wherein the apparatus is adapted to operate as a slave device, and wherein the interface controller is configured to terminate data transmission by:
driving the second wire of the serial bus while a receiving device is concurrently driving the second wire of the serial bus.

14. The apparatus of claim 9, wherein the serial bus is operated in accordance with an I3C protocol and the phase differential mode of operation corresponds to a high-data-rate (HDR) mode of operation defined by the I3C protocol.

15. The apparatus of claim 14, wherein the interface controller is configured to terminate data transmission by:
transmitting an HDR exit pattern on the serial bus.

16. The apparatus of claim 9, wherein the interface controller is configured to terminate data transmission by:
transmitting an HDR restart pattern on the serial bus.

17. A method performed at a receiving device coupled to a serial bus, comprising:
receiving first data from the serial bus while the serial bus is configured for a phase differential mode of operation;
enabling a driver coupled to a first wire of the serial bus while flow-control signaling is being transmitted over the serial bus; and
driving the first wire of the serial bus from a first signaling state to a second signaling state,
wherein driving the first wire of the serial bus to the second signaling state while the flow-control signaling is being transmitted is indicative of a request by the receiving device to have data transmission over the serial bus terminated.

18. The method of claim 17, wherein the receiving device comprises a master device, and wherein enabling the driver coupled to the first wire of the serial bus comprises:
causing a line driver coupled to the serial bus to exit a high impedance state.

19. The method of claim 17, wherein receiving the first data over the serial comprises:
decoding the first data from transitions between signaling states of the wires of the serial bus, wherein each wire of the serial bus is used to carry encoded data.

20. The method of claim 17, wherein the flow-control signaling comprises two or more pulses transmitted on a second wire of the serial bus after the first wire has been driven to the first signaling state.

21. The method of claim 17, wherein the serial bus is operated in accordance with an I3C protocol and the phase differential mode of operation corresponds to a high-data-rate (HDR) mode of operation defined by the I3C protocol.

22. The method of claim 21, further comprising:
receiving an HDR exit pattern from the serial bus, wherein the HDR exit pattern is associated with a termination of a current data transmission over the serial bus.

23. The method of claim 21, further comprising:
receiving an HDR restart pattern from the serial bus, wherein the HDR restart pattern is associated with a termination of a current data transmission over the serial bus.

24. An apparatus, comprising:
a first line driver coupled to a first wire of a multi-wire serial bus;
a second line driver coupled to a second wire of the multi-wire serial bus;
a phase differential mode encoder; and
an interface controller configured to:
receive first data from the serial bus while the serial bus is configured for a phase differential mode of operation;
enable the first line driver while flow-control signaling is being transmitted over the serial bus; and
drive the first wire of the serial bus from a first signaling state to a second signaling state,
wherein driving the first wire of the serial bus to the second signaling state while the flow-control signaling is being transmitted is indicative of a request by the apparatus to have data transmission over the serial bus terminated.

25. The apparatus of claim 24, wherein the apparatus comprises a master device, and wherein the first line driver is enabled by causing the first line driver to exit a high impedance state.

26. The apparatus of claim 24, wherein the phase differential mode encoder is configured to:
decode the first data from transitions between signaling states of the wires of the serial bus, wherein each wire of the serial bus is used to carry encoded data.

27. The apparatus of claim 24, wherein the flow-control signaling comprises two or more pulses transmitted on a second wire of the serial bus after the first wire has been driven to the first signaling state.

28. The apparatus of claim 27, wherein the apparatus comprises a master device, and wherein data transmission over the serial bus comprises:
driving the second wire of the serial bus while a transmitting device is concurrently driving the second wire of the serial bus.

29. The apparatus of claim 24, wherein the serial bus is operated in accordance with an I3C protocol and the phase differential mode of operation corresponds to a high-data-rate (HDR) mode of operation defined by the I3C protocol.

30. The apparatus of claim 29, further comprising:
receiving an HDR exit pattern or an HDR restart pattern from the serial bus, wherein the HDR exit pattern and the HDR restart pattern are associated with a termination of a current data transmission over the serial bus.
